(19) United States
(12) Patent Application Publication
(10) Pub. No.: US 2017/0251528 A1
(43) Pub. Date: Aug. 31, 2017

(54) ELECTRIC WATER HEATER HEATING DEVICE

(71) Applicant: Ka Lun Li, Hong Kong (CN)

(72) Inventor: Ka Lun Li, Hong Kong (CN)

(21) Appl. No.: 15/414,281

(22) Filed: Jan. 24, 2017

(30) Foreign Application Priority Data
Jan. 26, 2016 (HK) 16100829.9

(51) Int. Cl. H05B 6/10; F24H 1/16

(52) U.S. Cl. CPC H05B 6/108; F24H 1/162

(57) ABSTRACT

Electric water heater heating device comprising a housing composed of an upper cover and a lower shell, a metal guide tube and a magnetic coil which are mounted in the housing. The metal guide tube is designed as a spiral shape and is divided into two groups each including two layers. The metal spiral guide tube of a lower layer continuously winds inward from periphery to center, and the metal spiral guide tube of an upper layer continuously winds outward from center to periphery. The two groups of the metal spiral guide tubes are respectively arranged above and under the magnetic coil for heating. In the heating device electromagnetic pulse waves, which are excited by the magnetic coil according to magnetic coil principle, are used to penetrate at high speed the metal spiral guide tubes arranged above and under the magnetic coil to cause the metal spiral guide tubes to generate high heat. The water flows continuously in the guide tube, taking away the heat, as a result, the water in the guide tube is heated continuously without a break.

### CROSS-REFERENCE TO RELATED APPLICATION

The present application claims priority to Hong Kong Patent Application No. 16100829.9 (Hong Kong Patent No. HK1211174), filed Jan. 26, 2016, the entirety of which is incorporated herein by reference.

### FIELD OF THE INVENTION

The present invention relates to a technical field of household appliances, in particular to an electric water heater heating device in which electromagnetic pulse waves are used for heating.

### BACKGROUND OF THE INVENTION

Generally, electric water heaters for sale in the current market are divided into three categories: storage water type electric water heater, semi-storage water type electric heater and electric water heater with an instant water heating device.

An electric water heater with a storage water type heating device employs a heating tube inserted into water to directly heat the water with AC, which has a typical storage capacity of about 30 liters and a power consumption of about 2,000 watts. But there is a disadvantage that it is bulky with a long waiting time for heating water which will be a few hours if there are many family members. A semi-storage type electric water heater also employs a heating tube inserted into water for heating, but of which the heating time is shorter than that of the storage water type electric water heater. However, it has a large power consumption of about 4,000 watts, there is a disadvantage that if a shower and a shampoo are performed simultaneously, there would be no sufficient heat in the heated water and finally which have to be terminated in a rush without any fun of a bath. An electric water heater with an instant water heating device employs a cylindrical heating tube inserted into water, which is composed of an electric heating body and an insulating layer wrapped outside of the electric heating body, and the instant electric heater has an advantage that hot water is available as long as it is turned on. However, it needs a large power consumption of about 9000 watts if sufficient heat is required. Due to a surprising power consumption, it is likely to cause burning out at the power supply connection.

Therefore, all of the above-mentioned electric water heaters have defects such as easy fouling, slow heating, large power consumption, low thermal efficiency, high damage rate, short life, easy aging, easy leakage and poor safety. Thus, the present invention directly provides a further technical solution regarding the defects of the above types of electric water heaters.

### SUMMARY OF THE INVENTION

It is an object of the present invention to overcome the defects in prior art by providing an electric water heater heating device in which electromagnetic pulse waves, which are excited by a magnetic coil according to magnetic coil principle, are used to penetrate at high speed the metal spiral guide tubes around the magnetic coil to cause the metal spiral guide tubes to generate high heat. The water flows continuously in the guide tube, taking away the heat, accordingly, the water in the guide tube is heated continuously without a break.

An instant electric water heater heating device with a small size and a low power consumption is provided according to the present invention, the heating device is capable of instantly heating cold water at 1-2 degree Celsius to hot water at around 48 degree Celsius, and supplying the hot water continuously. Furthermore, compared to the electric water heater available on the market, it can save electric power by 70% or above.

The technical solution for obtaining the heating device according to the present invention is as follows: comprising a housing composed of an upper cover and a lower shell, a metal guide tube and a magnetic coil which are mounted in the housing. The metal guide tube is designed as a spiral shape and is divided into two groups each including two layers. The metal spiral guide tube of a lower layer continuously winds inward from periphery to center, and the metal spiral guide tube of an upper layer continuously winds outward from center to periphery. The two groups of metal spiral guide tubes are respectively arranged above and under the magnetic coil for heating. The number of the metal spiral guide tubes and the magnetic coils described above can be increased according to environmental requirements and the heater size.

In order to ensure to heat continuously the cold water in the metal spiral guide tube without any heat exchange, all of the metal spiral guide tubes can be separated from one another by a distance, which is not less than 0.5 mm and of which the value is taken where the highest efficiency occurs. In addition, the heating device of the present invention can work together with other appliances or devices, such as an indoor heating system or the like.

### BRIEF DESCRIPTION OF DRAWINGS

FIG. 1 is a schematic configuration view of an electric water heater heating device according to the present invention;

FIG. 2 is a schematic configuration and running view of the heating device within the electric water heater according to the present invention.

### DETAILED DESCRIPTION OF THE EMBODIMENTS

The present invention is further described with reference to an exemplary embodiment.

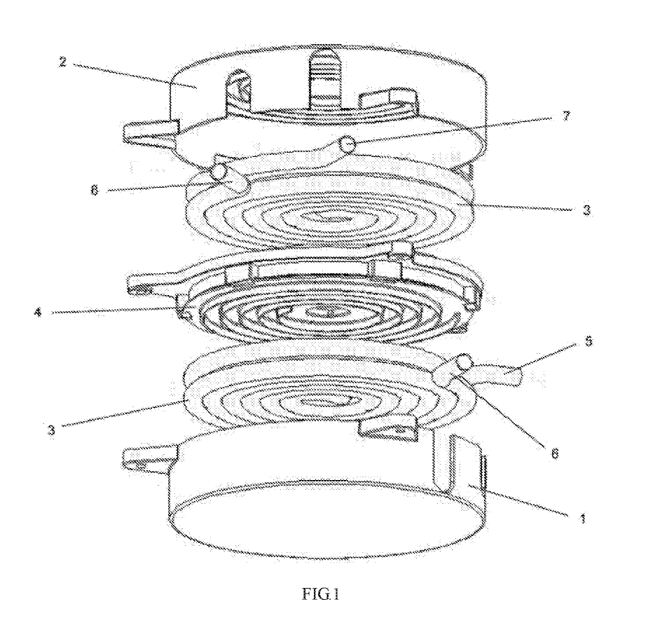

As shown in FIG. 1, an electric water heater is provided according to the present invention, comprising a housing composed of an upper cover 1 and a lower shell 2, a metal guide tube 3 and a magnetic coil 4 which are both mounted in the housing. The metal guide tube 3 is designed as a spiral shape and is divided into two groups each including two layers. The metal spiral guide tube 3 of a lower layer continuously winds inward from periphery to center, and the metal spiral guide tube of an upper layer continuously winds outward from center to periphery. The two groups of metal spiral guide tubes 3 are respectively arranged above and under the magnetic coil 4 for heating. Electromagnetic pulse waves, which are excited by the magnetic coil according to magnetic coil principle, are used to penetrate at high speed the metal spiral guide tubes 3 arranged above and under the magnetic coil 4 to cause the metal spiral guide tube to generate high heat. The water flows continuously in the guide tube, taking away a lot of heat, as a result, the water in the guide tube is heated continuously without a break.

Cold water is introduced from A inlet 5 of the upper layer of the first group of metal spiral guide tube 3, flows towards the center inside the guide tube, subsequently, flows towards the guide tube of the upper layer from the center, and finally, flows outside to B outlet 6 from the center along the metal spiral guide tube 3. B outlet 6 of the lower layer of the first group is communicated with C inlet 7 of the upper layer of the second group, the heated water is heated continuously within the second group of the metal spiral guide tube 3 in the same way until the water is leaded out from D outlet 8 of the metal spiral guide tube 3 of the lower layer of the second group.

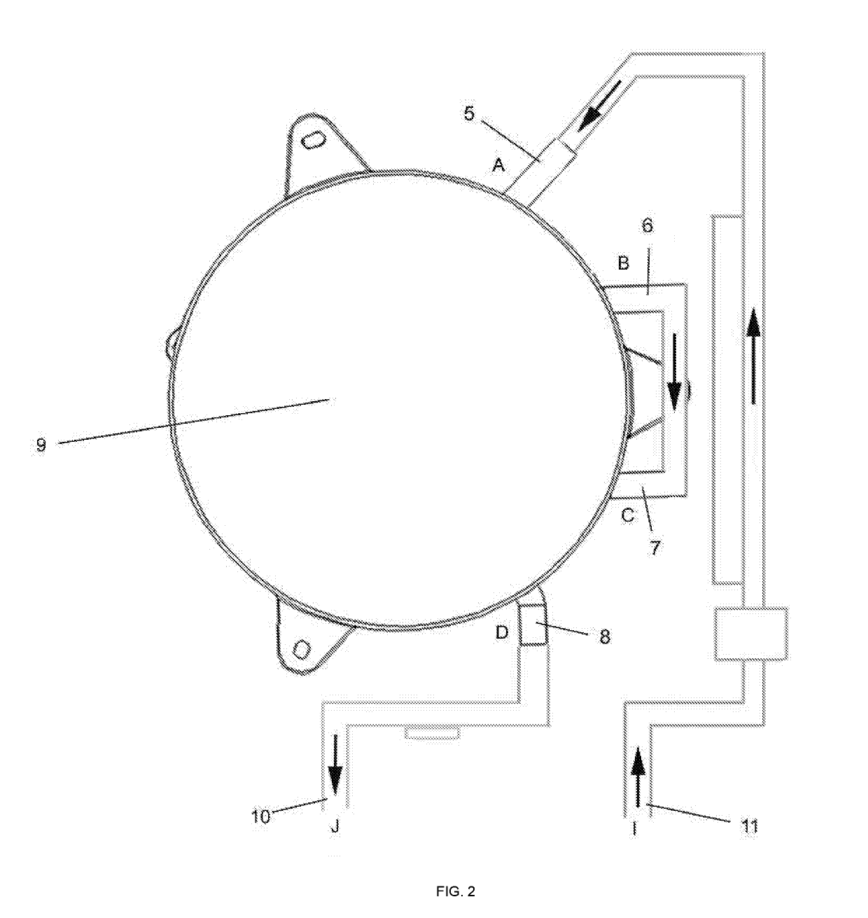

The configuration and running view of the heating device mounted on a water heater according to the present invention is shown in FIG. 2, cold water is heated at the first time when the cold water flows from I inlet 11 through A inlet 5 of the first group of the metal spiral guide tube 3 into heating device 9 of the water heater along the guide tube, and will be heated again when the heated water flows from B outlet 6 of the first group of metal spiral guide tube through C inlet 7 of the second group of metal spiral guide tube into the water heater heating device, after that the water flows outside from J hot water outlet 10 through D outlet 8 of the second group of metal spiral guide tube along the guide tube.

What is mentioned above is merely the preferred embodiments of the present invention, however, the present invention is not limited to the above-mentioned embodiments, and all embodiments which achieve the technical effects of the present invention with any same or similar means should fall within the protection scope of the present invention.

1. An electric water heater heating device, comprising
a housing including an upper cover and a lower shell, and
a metal guide tube and a magnetic coil which are both mounted in the housing,
characterized in that:
the metal guide tube is designed as a spiral shape and is divided into two groups, each including two layers; the metal spiral guide tube of a lower layer continuously winds inward from periphery to center, and the metal spiral guide tube of an upper layer continuously winds outward from center to periphery; and the two groups of metal spiral guide tubes are respectively arranged above and under the magnetic coil for heating.

2. The electric water heater heating device according to claim 1, wherein all of the metal spiral guide tubes are separated from one another by a distance.

3. The electric water heater heating device according to claim 1, wherein, in the heating device, electromagnetic pulse waves, which are excited by the magnetic coil according to magnetic coil principle, are used to penetrate at high speed the metal spiral guide tubes arranged above and under the magnetic coil to cause the metal spiral guide tube to generate high heat.

4. The electric water heater heating device according to claim 1, wherein the increasing number of the metal spiral guide tubes and the magnetic coils is due to environmental requirements and the heater size, and the heating device can also work together with an indoor heating system.
